(19) United States
(12) Patent Application Publication
(10) Pub. No.: US 2006/0160415 A1
(43) Pub. Date: Jul. 20, 2006

(54) Coupling and method for producing a hermetic seal

(76) Inventor: John A. Pollock, Wilton, NH (US)

Correspondence Address: Peter A. Nieves, Esq.,;Sheehan Phinney Bass + Green, PA, 1000 Elm Street, P.O. Box 3701, Manchester, NH, 03105-3701, US

(21) Appl. No.: 11/038,875

(22) Filed: Jan. 20, 2005

(51) Int. Cl. H01R 13/73

(52) U.S. Cl. 439/559

(57) ABSTRACT

A base has an opening therethrough and is made of a first material. A connector shell has a neck at least partially insertable within the opening of the base. The connector shell is made of a second material. A coefficient of thermal expansion of the first material is greater than a coefficient of thermal expansion of the second material. A conductor extends at least partially through the neck of the connector shell. Solder connects the neck to the base.

### CROSS-REFERENCE TO RELATED APPLICATION

This application claims priority to co-pending U.S. Nonprovisional Application entitled, “Coupling and Method for Producing a Hermetic Seal,” having Ser. No. 10/914,887, filed Aug. 10, 2004, which is incorporated herein by reference.

### FIELD OF THE INVENTION

The present invention is generally related to hermetic seal couplings and, more particularly, is related to a hermetically sealed connector system formed in a housing.

### BACKGROUND OF THE INVENTION

Components may be coupled to housings to form a connection and a hermetic seal. The housings may be made from a variety of materials having coefficients of thermal expansion (CTE) ranging from Kovar (CTE=5 ppm/° C.) to Aluminum (CTE=23 ppm/° C.). Components with a CTE less than or equivalent to the housing can be effectively joined and produce a hermetic seal with soft solder since this eliminates or limits solder tensile strain to acceptable limits during cool down from the soldering temperature.

However, when the component with a CTE greater than the housing, for example a steel component (CTE=15 ppm/° C.), is soldered to a Kovar housing, an effective solder joint is difficult to maintain since the strain in the joint upon cool down may exceed the failure strain of the solder. The use of hard solder, for example 80/20 Au/Sn, produces extremely high tensile stresses in the vicinity of the ultimate strength of the solder (40,000 psi) with low CTE housing materials. These stresses can produce at least two problems. First, the stresses can be passed on, in part, to the metal-to-glass seal interface and lead to seal failure (i.e. glass-to-metal separation or glass cracking). Second, the stresses can also produce failed solder joints particularly when any stress concentrator is present due to geometric factors or other external stresses applied during product processing or field use.

FIGS. 1-4 show a prior art method of joining an electrical component 100 to a housing 110. The component 100 has an electrical conductor 102 extending from at least one end. The electrical conductor 102 is electrically insulated from a component body 104 of the component 100 by an insulator 106. The component 100 is coupled to the housing 110 with solder that fills a gap 108 between an exterior surface 112 of the component 100 and an interior surface 114 of a hole formed in the housing 110. The housing 110 is often made from a material (typically Kovar) having a similar CTE as the component 100 (also typically Kovar) that is coupled thereto.

The component 100 and the housing 110 may be coupled with a soft solder, for example, Sn 62, Sn 63, Sn 96, or Sb 5; or a hard solder, for example, 80/20 Au/Sn. Soft solders are feasible structurally for many applications but are less desirable for other applications such as connectors where cables may provide high stress that may lead to eventual failure, through long-term creep. Hard solders provide necessary structural strength, but differences between the CTE of the housing 110 and component 100 (kovar, CTE=5 ppm/° C.) and the solder (CTE=15 ppm/° C.) can produce critically high stress levels in the solder joint. This tensile stress is imparted into the hard solder joint upon formation and remains in the solder joint for the life of the product due to the non-creep nature of the hard solder.

Steel is a common material for the component 100 for cost and performance reasons. In this configuration, a satisfactory solder joint may be formed when the component 100 is soldered to a housing 110 having a CTE greater than or equivalent to the CTE of the component 100, but an unsatisfactory solder joint is formed when the component 100 is soldered into a housing 110 having a CTE less than the component 100, since strain in the solder can be intolerable upon cool down. For example, a satisfactory solder joint is formed between a steel component and either a steel, stainless steel, Aluminum, Copper, or brass housing. An unsatisfactory solder joint is formed between a steel component and a Kovar housing (CTE=5 ppm/° C.).

Thus, a heretofore unaddressed need exists in the industry to address the aforementioned deficiencies and inadequacies.

### SUMMARY OF THE INVENTION

Embodiments of the present invention provide a hermetic coupling and a system and method for producing a hermetic seal between components and a housing. Briefly described in architecture, one embodiment of the system, among others, can be implemented as follows. A base has an opening therethrough and is made of a first material. A connector shell has a neck at least partially insertable within the opening of the base. The connector shell is made of a second material. A coefficient of thermal expansion of the first material is greater than a coefficient of thermal expansion of the second material. A conductor extends at least partially through the neck of the connector shell. Solder connects the neck to the base.

In another aspect, the invention features a method of coupling a component to a housing. The method includes the steps of: positioning a neck of a connector shell made of a second material at least partially within an opening through a base made of a first material, wherein a coefficient of thermal expansion of the first material is greater than a coefficient of thermal expansion of the second material; applying heat to the connector shell and the base; applying solder to a gap between the connector shell and the base to form a connector system; positioning the connector system in a hole formed in a housing; and connecting the connector system to the housing.

Other couplings, systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a cross-sectional view of a first component coupled to a housing in accordance with the prior art.

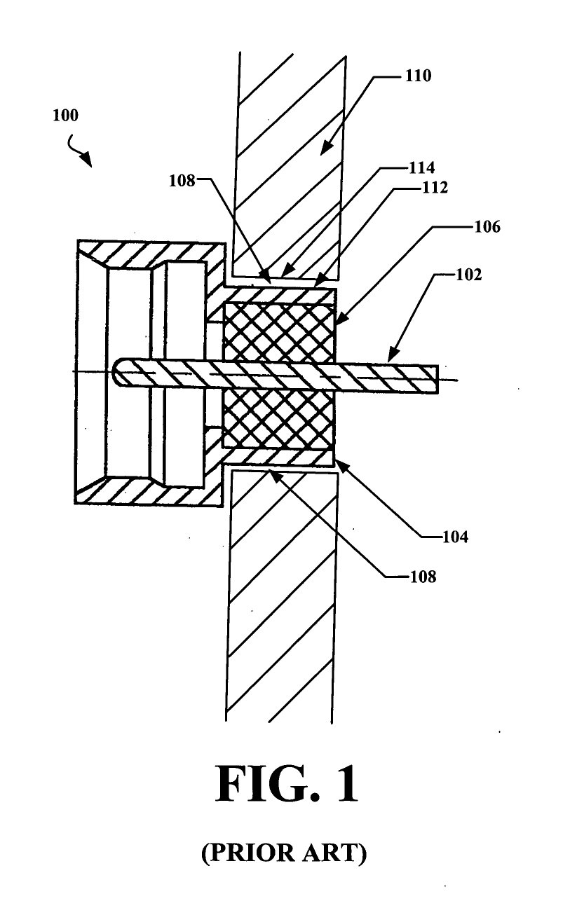

FIG. 2 is an end view of the first component of FIG. 1, in accordance with the prior art.

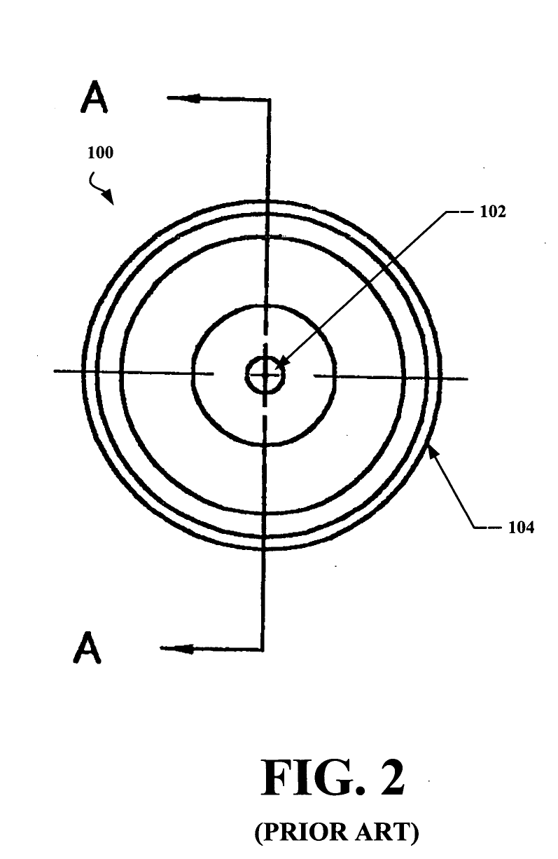

FIG. 3 is a first perspective view of the first component of FIG. 1, in accordance with the prior art.

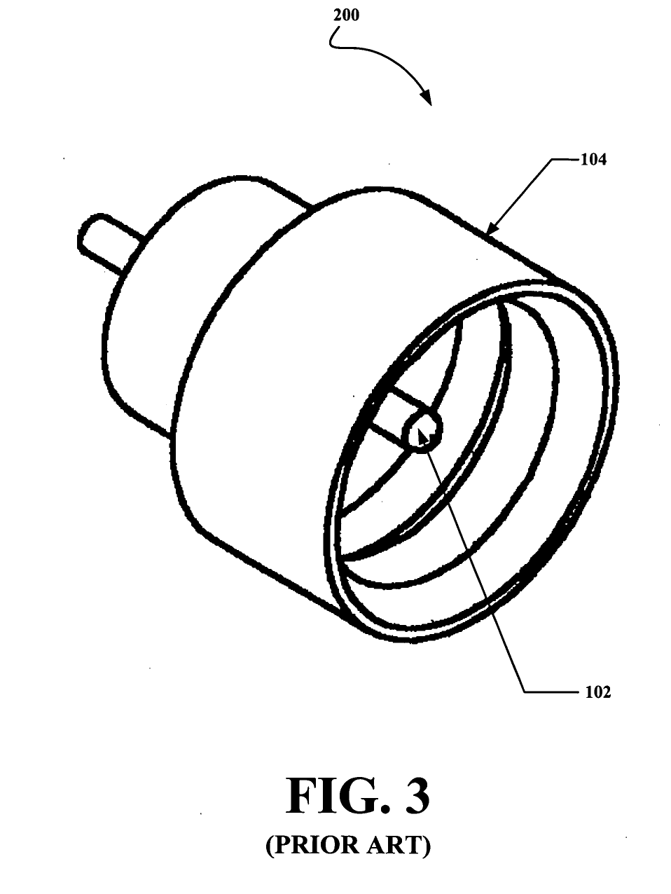

FIG. 4 is a second perspective view of the first component of FIG. 1, in accordance with the prior art.

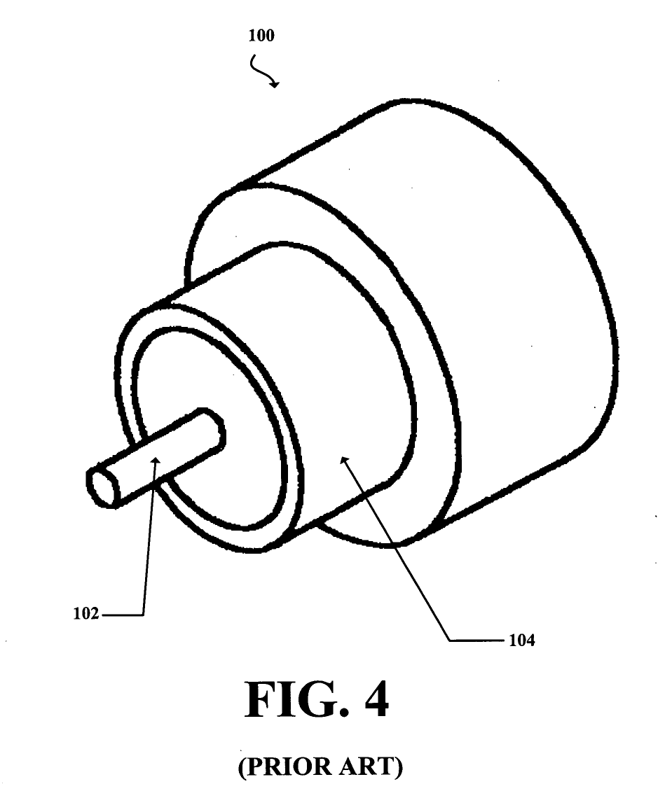

FIG. 5A is a cross-sectional view of a connector system, coupled and mounted within a housing in accordance with a first exemplary embodiment of the invention.

FIG. 5B is a magnified view of a point of mechanical connection between a base and a connector shell, in accordance with the first exemplary embodiment of the invention.

FIG. 6A is a cross-sectional, exploded view of the connector system of FIG. 5, in accordance with the first exemplary embodiment of the invention.

FIG. 6B is a cross-sectional view of the connector system of FIG. 6A coupled in accordance with the first exemplary embodiment of the invention.

FIG. 7 is a sectional, perspective view of the connector system of FIG. 5 uncoupled and mounted within a housing in accordance with the first exemplary embodiment of the invention.

FIG. 8 is a sectional, exploded, perspective view of the connector system of FIG. 5 in accordance with the first exemplary embodiment of the invention.

FIG. 9 is a flow chart describing one exemplary method for utilizing the first exemplary embodiment of the invention.

### DETAILED DESCRIPTION

For exemplary purposes, the following describes a connector system with a hermetic seal and a method of providing the same. It should be noted, however, that alternative connector systems with a hermetic seal may be provided in accordance with the present invention. The present invention is intended to include various connector systems where a solder joint between a connector shell of one material and a base of a different material provides a hermetic seal. The present invention is further intended to include various connector systems where a laser weld or other connection medium between a connector shell of one material and a base of a different material provides a hermetic seal.

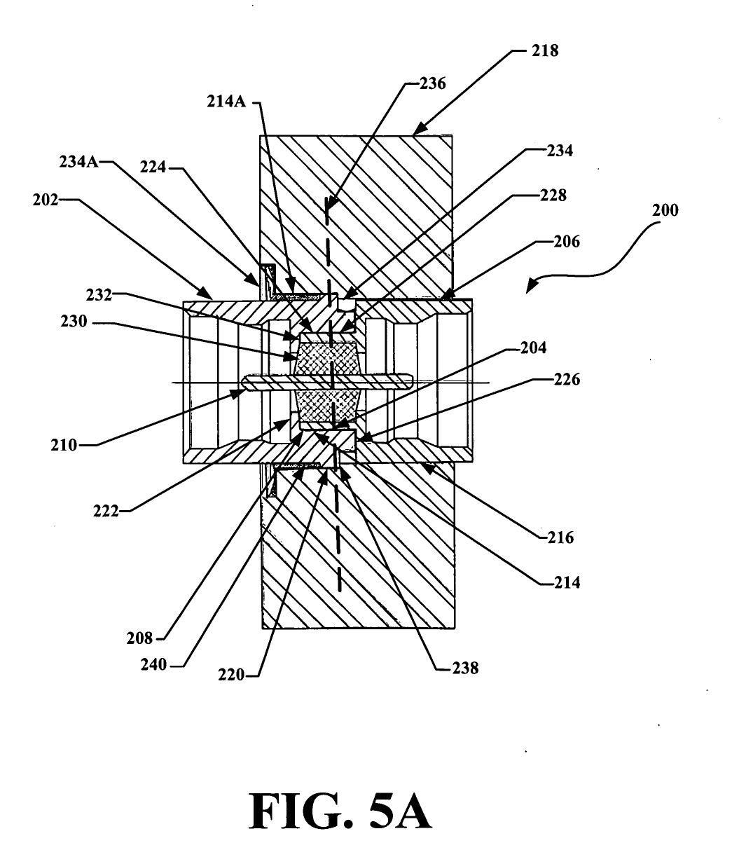

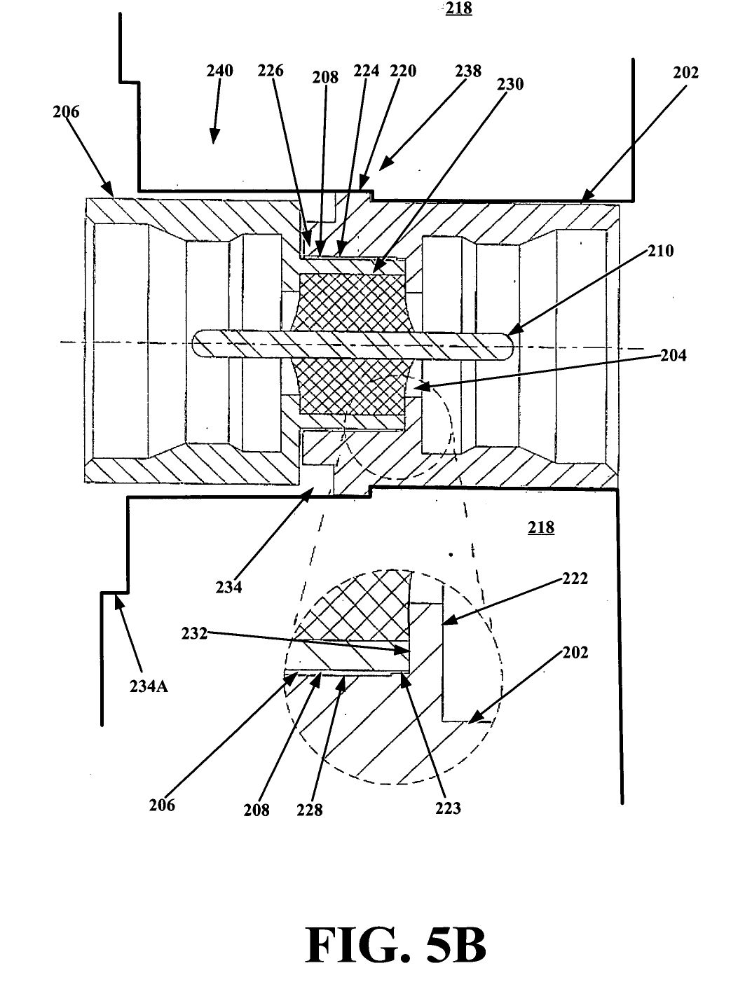

FIGS. 5A-8 show a first exemplary embodiment of a connector system 200 in accordance with the present invention. FIG. 5A is a cross-sectional view of a connector system, coupled and mounted within a housing in accordance with a first exemplary embodiment of the invention. FIG. 5B is a magnified view of a point of mechanical connection between a base and a connector shell, in accordance with the first exemplary embodiment of the invention. The connector system 200 contains a base 202 having an opening 204 therethrough and being made of a first material. The connector system 200 also contains a connector shell 206 having a neck 208 at least partially insertable within the opening 204 of the base 202. The connector shell 206 is made of a second material. A coefficient of thermal expansion of the first material is preferably greater than or equivalent to a coefficient of thermal expansion of the second material. A conductor 210 extends at least partially through the neck 208 of the connector shell 206. An integral connection 214 is formed between the neck 208 to the base 202.

As provided in the exemplary figures, the integral connection 214 is solder, although a laser weld or other known connection medium for hermetically connecting two elements may be used. When a solder joint is formed between two components, an inner and outer component, wherein the inner component is inserted at least partially into and soldered with the outer component, an unsatisfactory solder joint is formed when the outer component has a CTE less than the CTE of the inner component. As discussed herein, that type of solder joint is unsatisfactory because strain in the solder can be intolerable upon cool down. Therefore, as a rule, a satisfactory solder joint involves an outer component having a CTE greater than or substantially equivalent to a CTE of an inner component. This rule is important for forming a solder joint as the integral connection 214 between the base 202 (outer component) and the connector shell 206 (inner component) and for forming a solder joint between a housing 218 (outer component) and the connector system 200 (inner component).

Examples of the components that can utilize the connector system 200 include but are not limited to connectors, antennas, capacitors, radio frequency components, electromagnetic interference (EMI) capacitors, and other externally mounted housing connections. The connector system and method described can also be used to conduct the transmission of current, light, signals, sound, heat, fluids and/or gasses through the conductor 210, only some of which would have need for a volume of insulation 230. Also, the exemplary embodiments in the figures show only a single pin conductor, although those having ordinary skill in the art will recognize that a multi-pin arrangement may be created without departing from the invention described herein. A multi-pin arrangement may also require a keying feature to assure connected pins are properly aligned.

The connector system 200 may also include a volume of insulation 230 at least partially insulating the conductor 210 from the connector shell 206. The type of insulation 230 used will be at least partially dependent on the conductor 210 and the purpose for which the conductor 210 is used. If the conductor 210 is conducting electricity, the insulation 230 may be electrically insulating. If the conductor 210 is transmitting light, the insulation 230 may be a material that has lower light transmissive properties than the conductor 210. The insulation 230 may be made of glass or other materials. The thickness of the insulation 230 can vary based on the properties of the conductor 210 and contents transmitted therethrough. Integrity of the insulation 230 may be affected by the CTE of the connector shell 206 during heating and cool down. A connector shell 206 with a low CTE may be useful for protecting the integrity of the insulation.

As shown in FIG. 5A, the connector system 200 is designed to be received within a hole 216 formed within the housing 218. An example of a housing 218 that could make use of the connector system 200 described herein is a vacuum chamber or other airtight chamber. However, the housing 218 may also represent a barrier between different environmental conditions, including varying atmospheric pressures and temperatures. The housing 218 may be made of any of a variety of materials including Aluminum, stainless steel, brass, and Kovar.

The base 202 may also include a lip 220 integral with the base 202 and received by the housing 218 thereby providing support for the base 202. The housing 218 may also have a shoulder 238 to receive the lip 220.

The base 202 may also include an inner protrusion 222 formed therein, wherein the inner protrusion 222 and a portion of the opening 204 together form a cup 224 at a first end 226 of the base 202. The neck 208 is insertable within the cup 224 of the base 202. When the neck 208 is inserted within the cup 224, a gap 228 may exist between an inner side of the cup 224 and the neck 208. A width of the gap 228 may be between about 0.003 inches and about 0.007 inches. Of course, the gap 228 may have a different width without departing from the spirit of the invention. Also, the gap 228 may be designed to be smaller for a hard solder than it is for a soft solder. In addition, the surfaces that form the gap 228 may be designed to be solderable surfaces. If the surfaces that form the gap 228 are not solderable surfaces, those surfaces may be plated to improve their solderability.

As shown in FIG. 5B, the cup 224 may be oriented such that an inner diameter of the cup 224 is greater at the first end 226 of the base 202 than at the inner diameter of the cup 224 abutting the inner protrusion 222. This arrangement would allow the neck 208 to be substantially axially centered within the cup 224 while leaving space between the neck 208 and cup 224 for the insertion of solder 214. This arrangement may be achieved by having a stepped portion 223 at the inner diameter of the cup 224 abutting the inner protrusion 222. This arrangement may instead be achieved by gradually sloping the inner sides of the cup 224 radially inward along a length of the opening 204. Those having ordinary skill in the art will recognize other designs may be instituted with regards to the shape of the cup 224 to achieve the goals described herein. Similarly, the neck 208 may be made radially wider (not shown) at a first end 232 of the neck 208 to achieve the same goals.

As discussed, the coefficient of thermal expansion of the first material is greater than or substantially equivalent to the coefficient of thermal expansion of the second material. This arrangement increases the likelihood of a solid solder joint between the base 202 (outer component) and the connector shell 206 (inner component). Many materials exist that can be used as the first material and many materials exist that can be used as the second material. As an example, the first material may be steel, which has a coefficient of thermal expansion of 15 ppm/° C., and the second material may be Kovar, which has a coefficient of thermal expansion of 5 ppm/° C.

Solder 214 mechanically couples the neck 208 to the cup 224 to provide a complete hermetic connector system 200. The solder 214 may be a soft solder, for example, but not limited to, Sn 62, Sn 63, Sn 96, or Sb 5 with a CTE of 23-30 ppm/° C. Soft solder is desirable because it absorbs strain better than hard solder, thereby limiting stress levels. The gap 228 is sized to achieve a thick conformal solder joint. A conformal solder joint has a thickness sufficient to absorb strain without failure. The desired maximum width or radial gap of the gap 228 is the maximum gap that still allows capillary action of the solder. The designed gap 228 may be greater when using a soft solder than for a hard solder. For example, the gap 228 for use with soft solder may range around 0.003-0.007 inches, whereas the same gap 228 for use with hard solders (e.g., 80/20) may be smaller, such as around 0.0005-0.002 inches. The sizing of the gap 228 should provide for optimum capillary action. Solder preform is placed about a well 234 formed when the connector shell 206 is fitted within the base 202. Heat is applied to heat the component parts (i.e., the connector shell 206 and the base 202) and, in turn, melts the solder preform to fill at least a portion of the well 234 with molten solder. The solder 214 then flows into the gap 228 and, after hardening, provides a hermetic seal between the connector shell 206 and the base 202.

The connector system 200 may also be attached to the housing 218 by channel solder 214A. The channel solder 214A may be used to form a hermetic seal between the housing 218 and the connector system 200. The hole 216 in the housing 218 may be formed with a housing well 234A at one side of the hole 216. The hole 216 should be wider at the side with the housing well 234A, to receive the lip 220 of the base 202, which rests on the shoulder 238 within the hole 216. The space between the connector system 200 and an inner wall of the hole 216 forms a channel 240 between the housing well 234A and the lip 220, which may receive the channel solder 214A. The channel solder 214A should have a lower melting point than the solder 214 filling the gap 228, such that the channel solder 214A does not reflow, soften, or otherwise cause the component parts (i.e., base 202 and connector shell 206) joined by the solder 214 to become disengaged. The side of the hole 216 distal from the housing well 234A may be a narrower portion of the hole 216, allowing the connector system 200 to fit somewhat snugly within that portion of the hole 216 and centering the connector system 200 in the hole 216, such that the size of the channel 240 is substantially consistent on multiple sides of the connector system 200. Alternatively, the hole 216 may be snug only at the shoulder 238 to center the connector system 200. In this case, the side of the hole 216 distal from the housing well 234 may be a broader portion of the hole 216 as it is not a critical element of the hermetic seal and making this portion of the hole 216 narrow may accidentally form a capillary during soldering.

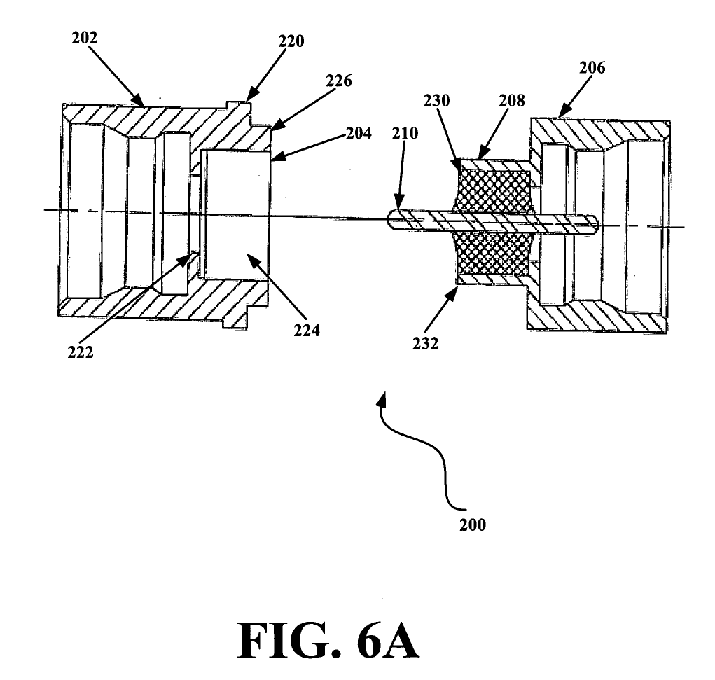

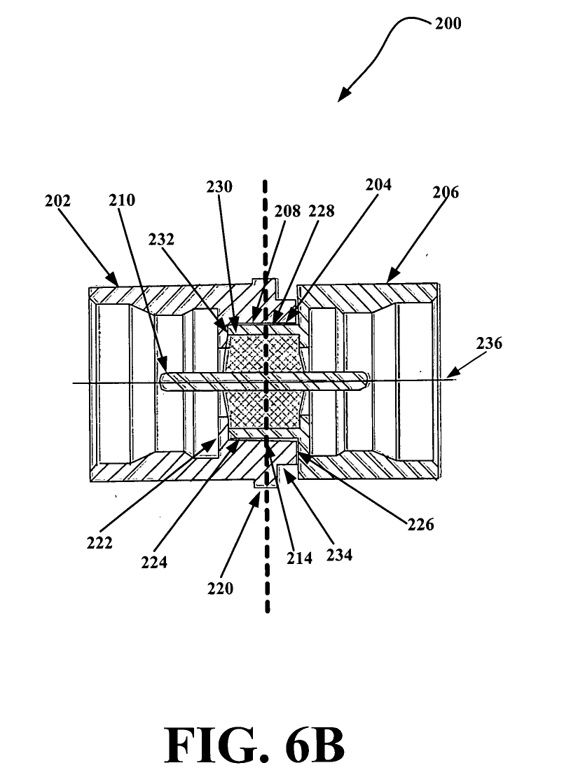

FIG. 6A is a cross-sectional, exploded view of the connector system of FIG. 5, in accordance with the first exemplary embodiment of the invention. FIG. 6B is a cross-sectional view of the connector system of FIG. 6A coupled in accordance with the first exemplary embodiment of the invention. It should be noted that, as shown in FIG. 6A, the connector system 200 is substantially symmetrical along the conductor 210. As shown in FIG. 6B, the connector system 200 is also substantially symmetrical along an axis 236 perpendicular to the conductor 210.

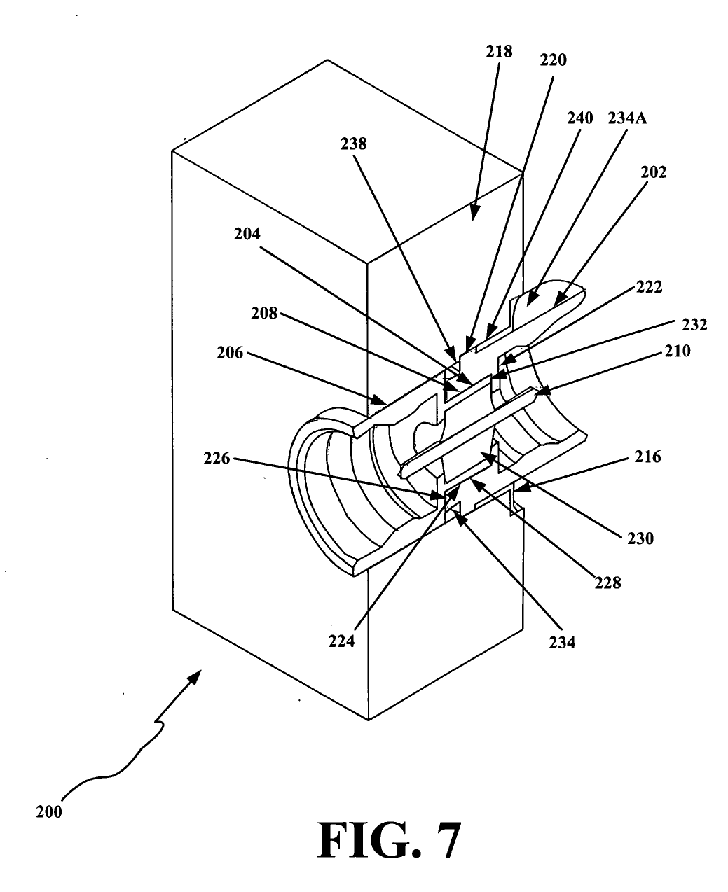

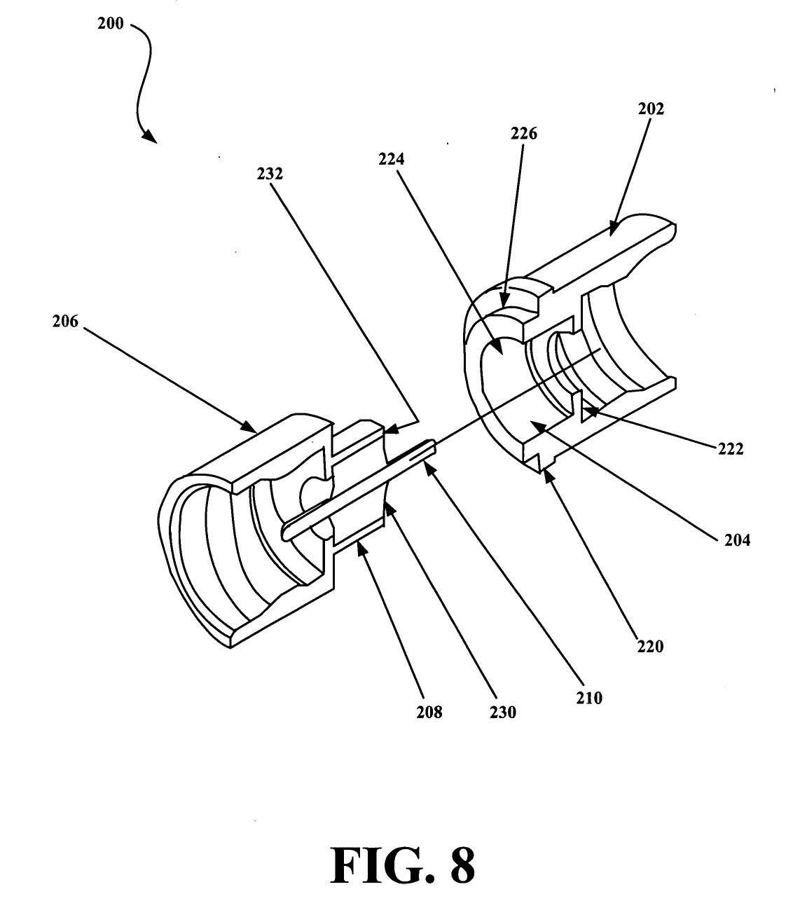

FIG. 7 and FIG. 8 are perspective drawings of the invention. FIG. 7 is a sectional, perspective view of the connector system of FIG. 5 uncoupled and mounted within a housing in accordance with the first exemplary embodiment of the invention. FIG. 8 is a sectional, exploded, perspective view of the connector system of FIG. 5 in accordance with the first exemplary embodiment of the invention.

In particular, it is understood that in accordance with this exemplary embodiment, a connector system 200 can be designed in which the same type of connector is mateable with either side of the connector system 200. For ease of use, the connector system 200 may be designed such that an industry-standard connector is mateable with the connector system 200, and the conductor 210 therein, on either end of the connector system 200. Similarly, the connector system 200 can be inserted into the hole 216 of the housing 218 such that either the connector shell 206 is on the housing well 234A side of the hole 216 (and hence soldered to the housing 218) or the base 202 is on the housing well 234A side of the hole 216 (and hence soldered to the housing 218) with substantially equivalent operability. This versatility allows a decision to be made between soldering the base 202 or the connector shell 206 to the housing 218 based on whether the material used to construct the base 202 or the material used to construct the connector shell 206 is more effectively soldered to the material used to construct the housing 218.

As discussed herein, a more hermetically reliable solder joint may be formed when the housing 218 has a CTE substantially equivalent to or greater than the CTE of the portion of the connector system 200 to which it is soldered. The difference in CTE between the housing 218 and the component part (base 202 or connector shell 206) to which the housing 218 is joined should not be too large. The greater the difference in CTE, when the housing 218 has a greater CTE, the more difficult it is to create a reliable hermetic seal. As an example, if the housing 218 is made of Aluminum (CTE=23 ppm/° C.), the connector shell 206 is Kovar (CTE=5 ppm/° C.), and the base 202 is steel (CTE=15 ppm/° C.), the housing 218 is preferably soldered to the base 202 because the base 202 has a CTE closer to the housing 218 than the connector shell 206.

The choice of: the first material, used for the base 202; the second material, used for the connector shell 206; and the housing 218 material are interrelated. If the housing 218 is going to be soldered to the base 202, the first material may have a CTE substantially equivalent to or less than the CTE of the housing 218 material. If the housing 218 is going to be soldered to the connector shell 206, the second material may have a CTE substantially equivalent to or less than the CTE of the housing 218 material. In either case, the CTE of the first material is preferably greater than or equivalent to the CTE of the second material.

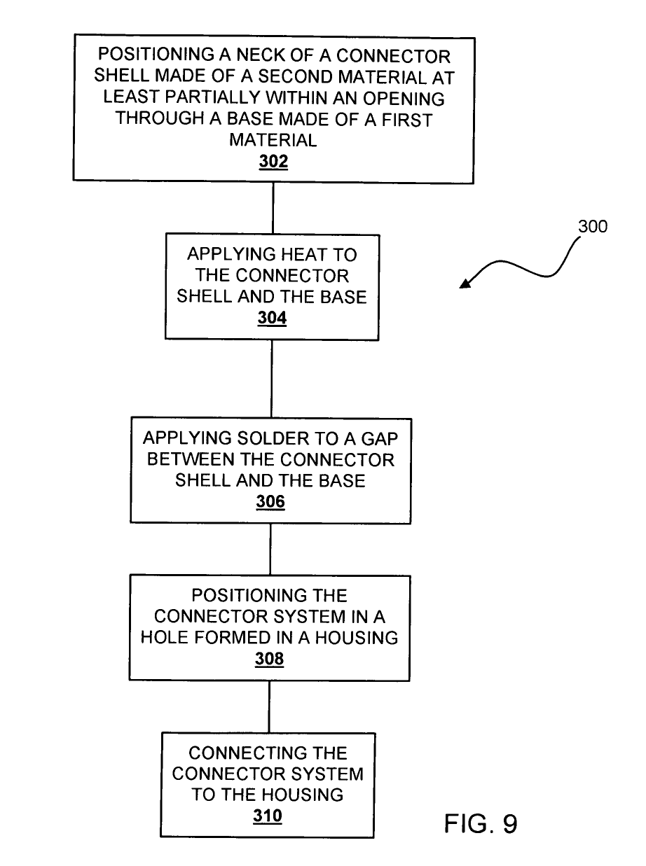

The flow chart of FIG. 9 shows the functionality and operation of a possible implementation of the connector system 200. In this regard, each block represents a module, segment, or step, which comprises one or more instructions for implementing the specified function. It should also be noted that in some alternative implementations, the functions noted in the blocks might occur out of the order noted in FIG. 9. For example, two blocks shown in succession in FIG. 9 may in fact be executed non-consecutively, substantially concurrently, or the blocks may sometimes be executed in the reverse order, depending upon the functionality involved, as will be further clarified herein.

As shown in FIG. 9, a method 300 for assembling the connector system 200, includes positioning the neck 208 of the connector shell 206, made of the second material, at least partially within the opening 204 through the base 202 made of the first material (block 302). The coefficient of thermal expansion of the first material is preferably greater than or substantially equivalent to the coefficient of thermal expansion of the second material. The method 300 also includes applying heat to the connector shell 206 and the base 202 (block 304). Assembling the connector system 200 also involves applying solder 214 to the gap 228 between the connector shell 206 and the base 202 (block 306). Applying solder 214 to the gap 228 may involve applying the solder 214 to the well 234 in communication with the gap 228. The method 300 also includes positioning the connector system 200 in the hole 216 formed in the housing 218 (block 308). The method 300 also includes connecting the connector system 200 to the housing 218 (block 310).

Connecting the connector system 200 to the housing 218 (block 310) may involve applying the channel solder 214A to the channel well 234A. The channel solder 214A, once heated, will at least partially fill the channel 240 to create a hermetic seal between the connector system 200 and the housing. Preferably, the channel solder 214A, once heated, entirely fills the channel 240 to create a hermetic seal, as only partially filling the channel may result in significant reliability issues for the hermetic seal. The connector system 200 may be heated in this process, although preferably not to a temperature that will significantly soften or reflow the solder 214.

Positioning the connector shell 206 within the opening 204 of the base 202 (block 302) may also include at least partially centering the connector shell 206 within the base 202. Centering the connector shell 206 may be done manually, by machine, or through mechanical design of the connector shell 206 or base 202 as has been described herein. One benefit to centering the connector shell 206 within the opening 204 of the base 202 is the creation of the at least partially uniform gap 228 between the connector shell 206 and the base 202, in which solder 214 may be applied for hermetically sealing and physically attaching the connector shell 206 to the base 202.

The method 200 may also include collecting any excess solder in the well 234 proximate to the gap 228. The method 200 may also include determining a properly hermetic coupling by observing the excess solder in the well 234 of the gap 228. A properly soldered coupling can be generally confirmed by examining the amount of solder remaining within the well 234. The amount of space within the gap 228 can be calculated based on the width of the gap 228. This amount of space is subtracted from the initial amount of solder material in the preforms. The amount of additional solder can be viewed within the well 234 after connector system 200 has been soldered. Based on the tolerances of the connector system 200 and the size of the well 234, an individual can determine acceptable amounts of solder that can remain in the well 234 and still provide an acceptable hermetic coupling. This procedure provides a quality control resource for the hermetic coupling.

It should be emphasized that the above-described embodiments of the present invention are merely possible examples of implementations, simply set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and protected by the following claims.

1. A connector system, comprising:
a base having an opening therethrough and made of a first material;
a connector shell having a neck at least partially insertable within the opening of the base, the connector shell made of a second material, wherein a coefficient of thermal expansion of the first material is greater than a coefficient of thermal expansion of the second material;
a conductor mounted within and extending at least partially through the neck of the connector shell; and
an integral connection between the neck and the base.

2. The connector system of claim 1, further comprising a housing having an opening sized to receive the base.

3. The connector system of claim 2 further comprising a lip integral with the base and received by the housing thereby providing support for the base.

4. The connector system of claim 1 further comprising an inner protrusion formed within the base, wherein the inner protrusion and a portion of the opening together form a cup at an end of the base and the neck is insertable within the cup of the base.

5. The connector system of claim 4 wherein an inner diameter of the opening abutting the inner protrusion is less than the inner diameter of the opening at the end of the base.

6. The connector system of claim 1, wherein the opening is sized, relative to the neck, to provide a gap between the base and the neck, wherein solder is mounted at least partially within the gap.

7. The connector system of claim 6 wherein the gap has a width of between about 0.003 inches and about 0.007 inches.

8. The connector system of claim 1, wherein the second material is Kovar and the first material is steel.

9. The connector system of claim 1 further comprising a volume of insulation at least partially insulating the conductor from the connector shell.

10. A method of installing a connector system in a housing, the method comprising the steps of:
positioning a neck of a connector shell made of a second material at least partially within an opening through a base made of a first material, wherein a coefficient of thermal expansion of the first material is greater than a coefficient of thermal expansion of the second material;
applying heat to the connector shell and the base;
applying solder to a gap between the connector shell and the base to form a connector system;
positioning the connector system in a hole formed in a housing; and
connecting the connector system to the housing.

11. The method of claim 10, wherein positioning the connector shell within the opening of the base further comprises the step of at least partially centering the connector shell within the base.

12. The method of claim 10, further comprising the step of collecting any excess solder in a well proximate to the gap.

13. The method of claim 10, further comprising the step of determining a properly hermetic coupling by observing the excess solder in a well at the mouth of the gap.

14. A connector system, comprising:
a base having an opening therethrough and made of a first material;
a connector shell having a neck at least partially insertable within the opening of the base, the connector shell made of a second material, wherein a coefficient of thermal expansion of the first material is greater than a coefficient of thermal expansion of the second material, and wherein the connector shell is mateable with the base; and
a conductor mounted within and extending at least partially through the neck of the connector shell.

15. The connector system of claim 14, further comprising solder connecting the neck to the base, thereby mating the neck and the base.

16. A connector system, comprising:
a base made of a first material;
a connector shell made of a second material, wherein the connector shell is integral with the base, and wherein a coefficient of thermal expansion of the first material is greater than a coefficient of thermal expansion of the second material, and wherein the connector shell is mateable with the base;
a conductor mounted within and extending at least partially through the connector shell; and
a housing having a hole, wherein the housing is mateable with one of the base and the connector shell, at the hole.

17. The connector system of claim 16, wherein the connector shell is hermetically sealed to the base and wherein the housing is hermetically sealed to one of the base and the connector shell.

18. The connector system of claim 16, further comprising a volume of insulation at least partially insulating the conductor from the connector shell.

19. The connector system of claim 16, wherein the second material is Kovar and the first material is steel.

20. The connector system of claim 16, wherein the connector shell is laser welded to the base.
